(19) United States
(12) Patent Application Publication
(10) Pub. No.: US 2017/0270906 A1
(43) Pub. Date: Sep. 21, 2017

(54) SYSTEMS AND METHODS FOR ADAPTIVE ACTIVE NOISE CANCELLATION FOR MULTIPLE-DRIVER PERSONAL AUDIO DEVICE

(71) Applicant: Cirrus Logic International Semiconductor Ltd., Edinburgh (GB)

(72) Inventors: Nitin Kwatra, Austin, TX (US); Jon D. Hendrix, Wimberley, TX (US); John L. Melanson, Austin, TX (US)

(73) Assignee: Cirrus Logic International Semiconductor Ltd., Edinburgh (GB)

(21) Appl. No.: 15/070,457

(22) Filed: Mar. 15, 2016

(51) Int. Cl. G10K 11/178

(52) U.S. Cl. CPC G10K 11/1786; G10K 2210/3028; G10K 2210/3046; G10K 2210/3023; G10K 2210/1081; G10K 2210/3027

(57) ABSTRACT

In accordance with embodiments of the present disclosure, a processing circuit may implement an adaptive filter, a first signal injection portion which injects a first additional signal into a first frequency range content source audio signal, and a second signal injection portion which injects a second additional signal into a second frequency range content source audio signal, wherein the first additional signal and the second additional signal are substantially different. The adaptive filter may have a response that generates the antinoise signal from the reference microphone signal to reduce the presence of the ambient audio sounds at the acoustic output, wherein the response of the adaptive filter is shaped in conformity with the reference microphone signal and the error microphone signal by adapting the response of the adaptive filter to minimize the ambient audio sounds in the error microphone signal, wherein the antinoise signal is combined with at least the first frequency range content source audio signal.

### FIELD OF DISCLOSURE

The present disclosure relates in general to adaptive noise cancellation in connection with an acoustic transducer, and more particularly, to detection and cancellation of ambient noise present in the vicinity of the acoustic transducer, and particularly for the cancellation of ambient noise in an audio system including multiple drivers for differing frequency bands.

### BACKGROUND

Wireless telephones, such as mobile/cellular telephones, cordless telephones, and other consumer audio devices, such as mp3 players, are in widespread use. Performance of such devices with respect to intelligibility can be improved by providing noise cancelling using a microphone to measure ambient acoustic events and then using signal processing to insert an antinoise signal into the output of the device to cancel the ambient acoustic events.

While many audio systems implemented for personal audio devices rely on a single output transducer, in the case of transducers mounted on the housing of a wireless telephone, or a pair of transducers when earspeakers are used or when a wireless telephone or other device employs stereo speakers, for high quality audio reproduction, it may be desirable to provide separate transducers for high and low frequencies, as in high quality earspeakers. However, when implementing active noise cancellation (ANC) in traditional systems, crossover filters present in an earspeaker housing may be present in the antinoise path, and thus may introduce latencies in the antinoise path, which may reduce the effectiveness of the ANC system.

Accordingly, it may be desirable to provide for a multiple transducer driver system that minimizes or reduces such latencies.

### SUMMARY

In accordance with the teachings of the present disclosure, certain disadvantages and problems associated with existing approaches to adaptive active noise cancellation may be reduced or eliminated.

In accordance with embodiments of the present disclosure, an integrated circuit for implementing at least a portion of a personal audio device may include a first output, a second output, a reference microphone input, an error microphone, and a processing circuit. The first output may provide a first output signal to a first transducer for reproducing a first frequency range content source audio signal comprising first frequency range content of a source audio signal, the first output signal including both the first frequency range content source audio signal and an antinoise signal for countering the effects of ambient audio sounds in an acoustic output of an earspeaker comprising the first transducer and a second transducer. The second output may provide a second output signal to the second transducer for reproducing a second frequency range content source audio signal comprising second frequency range content of the source audio signal, the second output signal including at least the second frequency range content source audio signal. The reference microphone may be configured to receive a reference microphone signal indicative of the ambient audio sounds. The error microphone input may be configured to receive an error microphone signal indicative of the output of the earspeaker and the ambient audio sounds at the earspeaker. The processing circuit may include an adaptive filter, a first signal injection portion which injects a first additional signal into the first frequency range content source audio signal, and a second signal injection portion which injects a second additional signal into the second frequency range content source audio signal, wherein the first additional signal and the second additional signal are substantially different. The adaptive filter may have a response that generates the antinoise signal from the reference microphone signal to reduce the presence of the ambient audio sounds at the acoustic output, wherein the response of the adaptive filter is shaped in conformity with the reference microphone signal and the error microphone signal by adapting the response of the adaptive filter to minimize the ambient audio sounds in the error microphone signal.

In accordance with embodiments of the present disclosure, a method may include generating a source audio signal for playback to a listener, receiving a reference microphone signal indicative of ambient audio sounds, receiving an error microphone signal indicative of an output of an earspeaker and the ambient audio sounds at the earspeaker, wherein the earspeaker comprises a first transducer for reproducing a first frequency range content source audio signal comprising first frequency range content of the source audio signal and a second transducer for reproducing a second frequency range content source audio signal comprising second frequency range content of the source audio signal, adaptively generating an antinoise signal for countering the effects of ambient audio sounds at an acoustic output of the earspeaker by adapting a response of an adaptive filter that filters the reference microphone signal in conformity with the error microphone signal and the reference microphone signal to minimize the ambient audio sounds in the error microphone signal, injecting a first additional signal into the first frequency range content source audio signal, injecting a second additional signal into the second frequency range content source audio signal, wherein the first additional signal and the second additional signal are substantially different, combining the antinoise signal with the first frequency range content source audio signal to generate a first output signal provided to the first transducer, and generating a second output signal provided to the second transducer, the second output signal including at least the second frequency range content source audio signal.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims. It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example wireless telephone and a pair of earbuds, in accordance with embodiments of the present disclosure;

FIG. 1B is a schematic diagram of selected circuits within the wireless telephone depicted in FIG. 1A, in accordance with embodiments of the present disclosure;

FIG. 2 is a block diagram of selected circuits within the wireless telephone depicted in FIG. 1A, in accordance with embodiments of the present disclosure; and

FIG. 3 is a block diagram of selected signal processing circuits and selected functional blocks of an ANC circuit, in accordance with embodiments of the present disclosure.

### DETAILED DESCRIPTION

The present disclosure encompasses noise cancelling techniques and circuits that can be implemented in a personal audio system, such as a wireless telephone and connected earbuds. The personal audio system may include an adaptive noise cancellation (ANC) circuit that may measure and attempt to cancel the ambient acoustic environment at the earbuds or another output transducer location such as on the housing of a personal audio device that receives or generates the source audio signal. Multiple transducers may be used, including a low-frequency and a high-frequency transducer that reproduce corresponding frequency bands of the source audio to provide a high quality audio output. The ANC circuit may generate one or more antinoise signals which may be respectively provided to one or more of the multiple transducers, to cancel ambient acoustic events at the transducers. A reference microphone may be provided to measure the ambient acoustic environment, which provides an input to one or more adaptive filters that may generate the one or more antinoise signals.

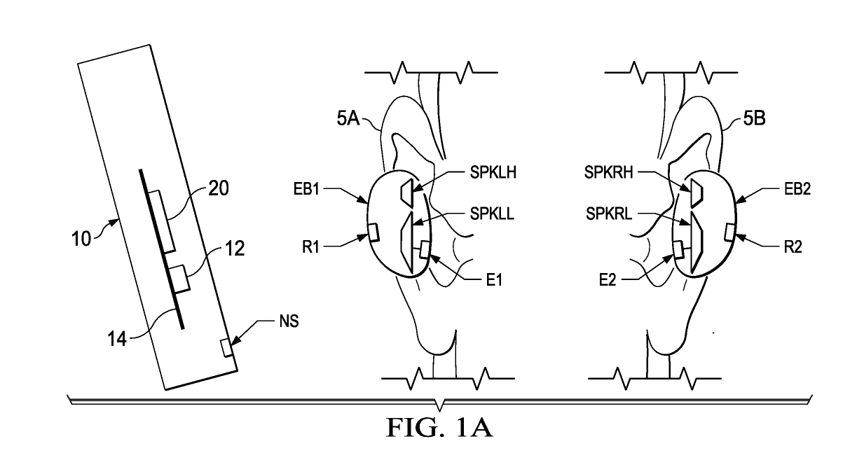

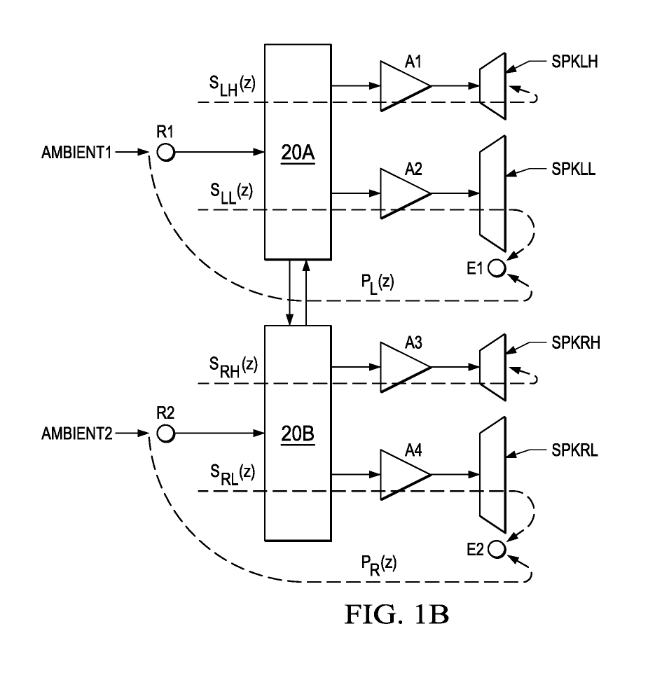

FIG. 1A illustrates a wireless telephone 10 and a pair of earbuds EB1 and EB2, each attached to a corresponding ear 5A, 5B of a listener, in accordance with embodiments of the present disclosure. Wireless telephone 10 may be an example of a device in which the techniques disclosed herein may be employed, but it is understood that not all of the elements or configurations illustrated in wireless telephone 10, or in the circuits depicted in subsequent illustrations, are required. Wireless telephone 10 may be coupled to earbuds EB1, EB2 by a wired or wireless connection (e.g., a BLUETOOTH™ connection). Earbuds EB1, EB2 may each have a corresponding pair of transducers SPKLH/SPKLL and SPKRH/SPKRL, respectively, which may reproduce source audio including distant speech received from wireless telephone 10, ringtones, stored audio program material, and injection of near-end speech (i.e., the speech of the user of wireless telephone 10). Transducers SPKLH and SPKRH may comprise high-frequency transducers or “tweeters” that reproduce the higher range of audible frequencies and transducers SPKLL and SPKRL may comprise low-frequency transducers or “woofers” that reproduce a lower range of audio frequencies. The source audio may also include any other audio that wireless telephone 10 is to reproduce, such as source audio from webpages or other network communications received by wireless telephone 10 and audio alerts, such as battery low and other system event notifications. Reference microphones R1, R2 may be provided on a surface of a housing of respective earbuds EB1, EB2 for measuring the ambient acoustic environment. Another pair of microphones, error microphones E1, E2, may be provided in order to further improve the ANC operation by providing a measure of the ambient audio combined with the audio reproduced by respective transducer pairs SPKLH/SPKLL and SPKRH/SPKRL close to corresponding ears 5A, 5B, when earbuds EB1, EB2 are inserted in the outer portion of ears 5A, 5B.

Wireless telephone 10 may include ANC circuits and features that inject antinoise signals into one or more of transducers SPKLH, SPKLL, SPKRH and SPKRL to improve intelligibility of the distant speech and other audio reproduced by transducers SPKLH, SPKLL, SPKRH and SPKRL. A circuit 14 within wireless telephone 10 may include an audio integrated circuit 20 that receives the signals from reference microphones R1, R2, a near speech microphone NS, and error microphones E1, E2 and interfaces with other integrated circuits, such as an RF integrated circuit 12 containing the wireless telephone transceiver. In other implementations, the circuits and techniques disclosed herein may be incorporated in a single integrated circuit that comprises control circuits and other functionality for implementing the entirety of the personal audio device, such as, for example, an MP3 player-on-a-chip integrated circuit. Alternatively, the ANC circuits may be included within the housing of earbuds EB1, EB2 or in a module located along wired connections between wireless telephone 10 and earbuds EB1, EB2. For the purposes of illustration, the ANC circuits may be described as provided within wireless telephone 10, but the above variations are understandable by a person of ordinary skill in the art and the consequent signals that are required between earbuds EB1, EB2, wireless telephone 10, and a third module, if required, can be easily determined for those variations. Near speech microphone NS may be provided at a housing of wireless telephone 10 to capture near-end speech, which may be transmitted from wireless telephone 10 to the other conversation participant(s). Alternatively, near speech microphone NS may be provided on the outer surface of the housing of one of earbuds EB1, EB2, on a boom affixed to one of earbuds EB1, EB2, on a pendant located between wireless telephone 10 and either or both of earbuds EB1, EB2, or other suitable location.

FIG. 1B illustrates a simplified schematic diagram of audio integrated circuits 20A, 20B that include ANC processing, as coupled to reference microphones R1, R2, which provide a measurement of ambient audio sounds Ambient1, Ambient2 which may be filtered by ANC processing circuits within audio integrated circuits 20A, 20B located within corresponding earbuds EB1, EB2, or within a single integrated circuit such as integrated circuit 20 which combines audio integrated circuits 20A and 20B within wireless telephone 10. Audio integrated circuits 20A, 20B may generate outputs for their corresponding channels that are amplified by an associated one of amplifiers A1-A4 and which are provided to the corresponding transducer pairs SPKLH/SPKLL and SPKRH/SPKRL. Audio integrated circuits 20A, 20B may receive the signals (wired or wireless depending on the particular configuration) from reference microphones R1, R2, near speech microphone NS and error microphones E1, E2. Audio integrated circuits 20A, 20B may also interface with other integrated circuits such as RF integrated circuit 12 which may comprise a wireless telephone transceiver as shown in FIG. 1A. In other configurations, the circuits and techniques disclosed herein may be incorporated in a single integrated circuit that includes control circuits and other functionality for implementing the entirety of the personal audio device, such as an MP3 player-on-a-chip integrated circuit. Alternatively, multiple integrated circuits may be used, for example, when a wireless connection is provided from each of earbuds EB1, EB2 to wireless telephone 10 and/or when some or all of the ANC processing is performed within earbuds EB1, EB2 or a module disposed along a cable connecting wireless telephone 10 to earbuds EB1, EB2.

In general, the ANC techniques illustrated herein may measure ambient acoustic events (as opposed to the output of transducers SPKLH, SPKLL, SPKRH and SPKRL and/or the near-end speech) impinging on reference microphones R1, R2 and may also measure the same ambient acoustic events impinging on error microphones E1, E2. The ANC processing circuits of integrated circuits 20A, 20B may individually adapt an antinoise signal generated from the output of the corresponding reference microphone R1, R2 to have a characteristic that minimizes the amplitude of the ambient acoustic events at the corresponding error microphone E1, E2. Because acoustic path P_{L}(z) extends from reference microphone R1 to error microphone E1, the ANC circuit in audio integrated circuit 20A may estimate acoustic path P_{L}(z) and remove effects of electro-acoustic paths S_{LH}(z) and S_{LL}(z) that represent, respectively, the response of the audio output circuits of audio integrated circuit 20A and the acoustic/electric transfer function of transducers SPKLH and SPKLL. The estimated responses S_{LH}(z) and S_{LL}(z) may include the coupling between transducers SPKLH, SPKLL and error microphone E1 in the particular acoustic environment which may be affected by the proximity and structure of ear 5A and other physical objects and human head structures that may be in proximity to earbud EB1. Similarly, audio integrated circuit 20B may estimate acoustic path P_{R}(z) and remove effects of electro-acoustic paths S_{RH}(z) and S_{RL}(z) that represent, respectively, the response of the audio output circuits of audio integrated circuit 20B and the acoustic/electric transfer function of transducers SPKRH and SPKRL.

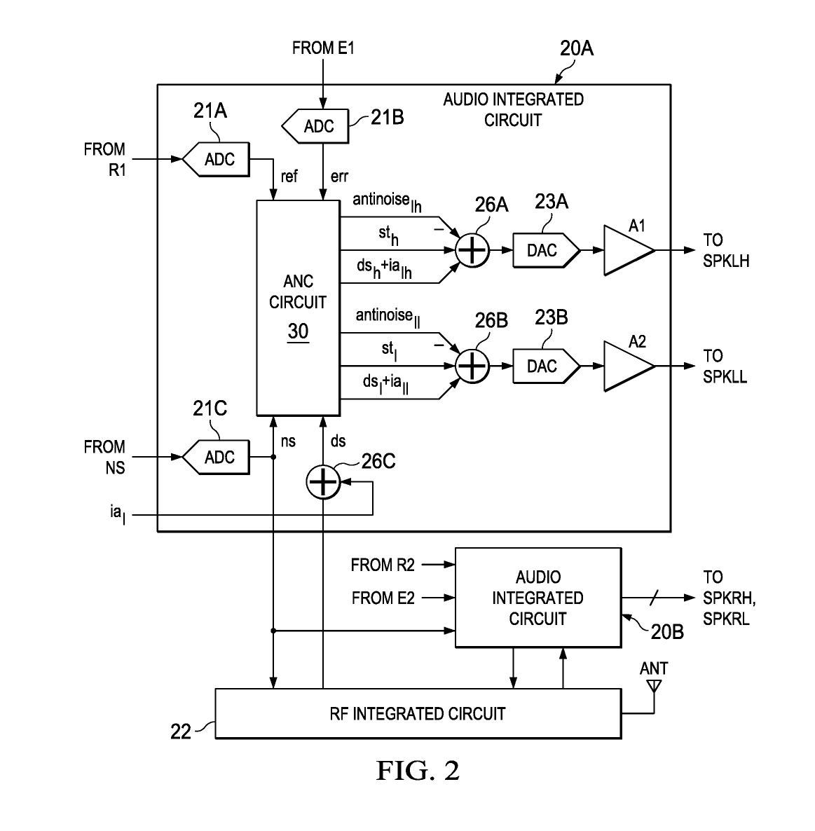

Referring now to FIG. 2, circuits within earbuds EB1, EB2 and/or wireless telephone 10 are shown in a block diagram, in accordance with embodiments of the present disclosure. The circuit shown in FIG. 2 may further apply to other configurations mentioned above, except that signaling between CODEC integrated circuit 20 and other units within wireless telephone 10 may be provided by cables or wireless connections when audio integrated circuits 20A, 20B are located outside of wireless telephone 10, e.g., within corresponding earbuds EB1, EB2. In such a configuration, signaling between a single integrated circuit 20 that implements integrated circuits 20A-20B and error microphones E1, E2, reference microphones R1, R2 and transducers SPKLH, SPKLL, SPKRH and SPKRL may be provided by wired or wireless connections when audio integrated circuit 20 is located within wireless telephone 10. In the illustrated example, audio integrated circuits 20A, 20B are shown as separate and substantially identical circuits, so only audio integrated circuit 20A will be described in detail below.

Audio integrated circuit 20A may include an analog-to-digital converter (ADC) 21A for receiving the reference microphone signal from reference microphone R1 and generating a digital representation ref of the reference microphone signal. Audio integrated circuit 20A may also include an ADC 21B for receiving the error microphone signal from error microphone E1 and generating a digital representation err of the error microphone signal, and an ADC 21C for receiving the near speech microphone signal from near speech microphone NS and generating a digital representation of near speech microphone signal ns. (Audio integrated circuit 20B may receive the digital representation of near speech microphone signal ns from audio integrated circuit 20A via the wireless or wired connections as described above.) Audio integrated circuit 20A may generate an output for driving transducer SPKLH from an amplifier A1, which may amplify the output of a digital-to-analog converter (DAC) 23A that receives the output of a combiner 26A. A combiner 26C may combine downlink speech ds, which may be received from a radio frequency (RF) integrated circuit 22, and left-channel internal audio signal iaₗ, which as so combined may comprise a left-channel source audio signal. Combiner 26A may combine source audio signal dsₕ+iaₗₕ, which is the high-frequency band component of the output of combiner 26C with high-frequency band antinoise signal antinoiseₗₕ generated by a left-channel ANC circuit 30, which by convention has the same polarity as the noise in reference microphone signal ref and may therefore be subtracted by combiner 26A. Combiner 26A may also combine an attenuated high-frequency portion of near speech signal ns, i.e., sidetone information stₕ, so that the user of wireless telephone 10 hears their own voice in proper relation to downlink speech ds. Near speech signal ns may also be provided to RF integrated circuit 22 and may be transmitted as uplink speech to a service provider via an antenna ANT. Similarly, left-channel audio integrated circuit 20A may generate an output for driving transducer SPKLL from an amplifier A2, which may amplify the output of a digital-to-analog converter (DAC) 23B that receives the output of a combiner 26B. Combiner 26B may combine source audio signal dsₗ-iaₗₗ, which is the low-frequency band component of the output of combiner 26C with low-frequency band antinoise signal antinoiseₗₗ generated by ANC circuit 30, which by convention has the same polarity as the noise in reference microphone signal ref and may therefore be subtracted by combiner 26B. Combiner 26B may also combine an attenuated portion of near speech signal ns, i.e., sidetone low-frequency information stₗ.

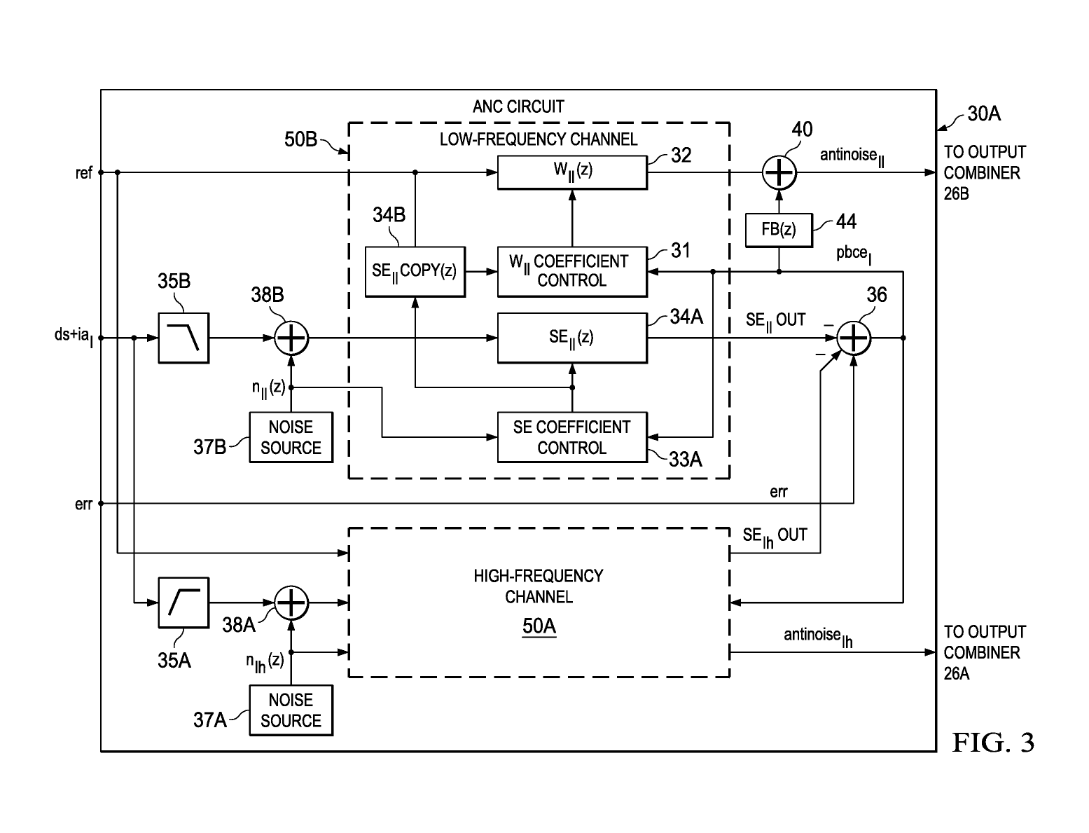

Referring now to FIG. 3, a block diagram of selected components of an ANC circuit 30A are shown, as may be used to implement at least a portion of audio integrated circuit 20A of FIG. 2. A substantially identical circuit may be used to implement audio integrated circuit 20B, with changes to the channel labels within the diagram as noted below. ANC circuit 30A may include high-frequency channel 50A and a low-frequency channel 50B, for generating antinoise signals antinoiseₗₕ and antinoiseₗₗ, respectively. In the description below, where signal and response labels contained the letter “l” indicating the left channel, the letter would be replaced with “r” to indicate the right channel in another circuit according to FIG. 3 as implemented within audio integrated circuit 20B of FIG. 2. Where signals and responses are labeled with the letter “1” for low-frequency in low-frequency channel 50B, the corresponding elements in high-frequency channel 50A would be replaced with signals and responses labeled with the letter “r.”

In ANC circuit 30A, an adaptive filter 32 may receive reference microphone signal ref and under ideal circumstances, may adapt its transfer function Wₗₗ(z) to be Pₗ(z)/Sₗₗ(z) to generate a feedforward component of antinoise signal antinoiseₗₗ (which may, as described below, be combined by combiner 40 with a feedback component of antinoise signal antinoiseₗₗ to generate antinoise signal antinoiseₗₗ). The coefficients of adaptive filter 32 may be controlled by a W coefficient control block 31 that uses a correlation of two signals to determine the response of adaptive filter 32, which may generally minimize, in a least-mean squares sense, those components of reference microphone signal ref that are present in error microphone signal err. While the example disclosed herein may use an adaptive filter 32 implemented in a feed-forward configuration, the techniques disclosed herein may be implemented in a noise-cancelling system having fixed or programmable filters, where the coefficients of adaptive filter 32 may be pre-set, selected or otherwise not continuously adapted, and also alternatively or in combination with the fixed-filter topology, the techniques disclosed herein can be applied in feedback ANC systems or hybrid feedback/feed-forward ANC systems. Signals received as inputs to W coefficient control block 31 may include the reference microphone signal ref as shaped by a copy of an estimate of the response Sₗₗ(z) of the secondary path provided by a filter 34B and a playback corrected error signal pbceₗ generated by a combiner 36 from error microphone signal err. By transforming reference microphone signal ref with a copy of the estimate of the response Sₗₗ(z) of the secondary path, SEₗₗCOPY(z), and minimizing the portion of the error signal that correlates with components of reference microphone signal ref, adaptive filter 32 may adapt to the desired response of Pᵣ(z)/Sₗₗ(z).

In addition, source audio signal ds+iaₗ including downlink audio signal ds and internal audio signal iaₗ may be processed by a secondary path filter 34A having response SEₗₗ(z), of which response SEₗₗCOPY(z) is a copy. Low-pass filter 35B may filter source audio signal ds+iaₗ before it is received by low-frequency channel 50B, passing only the frequencies to be rendered by low-frequency transducer SPKLL (or SPKRL in the case of ANC circuit 30B). Similarly, high-pass filter 35A may filter the source audio signal (ds+iaₗ) before it is received by high-frequency channel 50A, passing only frequencies to be rendered by the high-frequency transducer SPKLH (or SPKRH in the case of ANC circuit 30B). Thus, high-pass filter 35A and low-pass filter 35B form a crossover filter with respect to source audio signal ds+iaₗ, so that only the appropriate frequencies may be passed to high-frequency channel 50A and low-frequency channel 50B, respectively, and having bandwidths appropriate to respective transducers SPKLH, SPKLL or SPKRH, SPKRL. By injecting an inverted amount of source audio signal ds+iaₗ that has been filtered by response SEₗₗ(z), adaptive filter 32 may be prevented from adapting to the relatively large amount of source audio present in error microphone signal err. That is, by transforming the inverted copy of source audio signal ds+iaₗ with the estimate of the response of path Sₗₗ(z), the source audio that is removed from error microphone signal err before processing should match the expected version of source audio signal ds+iaₗ reproduced at error microphone signal err. The source audio amounts may approximately match because the electrical and acoustical path of Sₗₗ(z) is the path taken by source audio signal ds+iaₗ to arrive at error microphone E.

Filter 34B may not be an adaptive filter, per se, but may have an adjustable response that is tuned to match the response of secondary path adaptive filter 34A, so that the response of filter 34B tracks the adapting of secondary path adaptive filter 34A. To implement the above, secondary path adaptive filter 34A may have coefficients controlled by an SE coefficient control block 33A. For example, SE coefficient control block may correlate noise signal nₗₗ(z) and a playback corrected error signal pbceₗ in order to reduce the playback corrected error signal pbceₗ. Secondary path adaptive filter 34A may process the low or high-frequency source audio ds+iaₗ to provide a signal representing the expected source audio delivered to error microphone E. Secondary path adaptive filter 34A may thereby be adapted to generate a signal from source audio signal ds+iaₗ, that when subtracted from error microphone signal err, forms playback corrected error signal pbceₗ including the content of error microphone signal err that is not due to source audio signal ds+iaₗ. Combiner 36 may remove the filtered source audio signal ds+iaₗ from error microphone signal err to generate the above-described playback corrected error signal pbceₗ.

As a result of the foregoing, each of high-frequency channel 50A and low-frequency channel 50B may operate independently to generate respective antinoise signals antinoiseₗₕ and antinoiseₗₗ.

As depicted in FIG. 3, in some embodiments ANC circuit 30A may also comprise feedback filter 44. Feedback filter 44 may receive the playback corrected error signal pbceₗ and may apply a response FBₗ(z) to generate a feedback antinoise component of the antinoise signal antinoiseₗₗ based on the playback corrected error. The feedback antinoise component of the antinoise signal may be combined by combiner 40 with the low-frequency feedforward antinoise component of the antinoise signal generated by adaptive filter 32 to generate the low-frequency antinoise signal antinoiseₗₗ which in turn may be provided to combiner 26B that combines the low-frequency antinoise signal with the low-frequency source audio signal to be reproduced by an output transducer (e.g., SPKLL or SPKRL). Because content of an ANC feedback signal is typically in lower-frequencies in many ANC systems, the feedback antinoise component generated by feedback filter 44 may be combined by combiner 40 with the low-frequency antinoise component generated by adaptive filter 32 of low-frequency channel 50B rather than being combined with the high-frequency antinoise component generated by adaptive filter 32 of high-frequency channel 50A. Although FIG. 3 depicts presence of a feedback filter 44, in some embodiments, feedback filter 44 may not be present and no feedback antinoise component may be generated, in which case combiner 40 may also not be present and the low-frequency antinoise signal antinoiseₗₗ may be the low-frequency feedforward antinoise component of the antinoise signal generated by adaptive filter 32.

As shown in FIG. 3, a noise source 37A may inject a noise signal nₗₕ(z) into the high-frequency component of the source audio signal ds+iaₗ generated by high-pass filter 35A, such that a combiner 38A combines the noise signal nₗₕ(z) and the high-frequency component of the source audio signal ds+iaₗ into a combined signal that is processed by high-frequency channel 50A. Similarly, a noise source 37B may inject a noise signal nₗₗ(z) into the low-frequency component of the source audio signal ds+iaₗ generated by low-pass filter 35B, such that a combiner 38B combines the noise signal nₗₗ(z) and the low-frequency component of the source audio signal ds+iaₗ into a combined signal that is processed by low-frequency channel 50B. In order for the responses of the secondary path adaptive filters 34A of each of high-frequency channel 50A and low-frequency channel 50B to converge (e.g., for response SEₗₗ(z) to converge to Sₗₗ(z) and response SEₗₕ(z) to converge to Sₗₕ(z)), the noise signal nₗₕ(z) generated by noise source 37A may be substantially different (e.g., uncorrelated with, phase delayed with respect to) the noise signal nₗₗ(z) generated by noise source 37B. These substantially different noise signals may comprise white noise signals which are shaped in the frequency domain to protect speaker drivers (e.g., amplifiers A1, A2, A3, A4) from certain frequency contents or to psychoacoustically mask the effect of the noise signals to a user's ears. For example, noise sources 37A and 37B may generate a noise signal in accordance with those techniques described in U.S. Pat. Pub. No. 20120308027 and U.S. Ser. No. 14/252,235 entitled “Frequency-Shaped Noise-Based Adaptation of Secondary Path Adaptive Response in Noise-Canceling Personal Audio Devices,” which are incorporated herein by reference. As shown in FIG. 3, noise signals nₗₕ(z) and nₗₗ(z) may also be injected into each of high-frequency channel 50A and low-frequency channel 50B where such signals may be input to an SE coefficient control block (e.g., SE coefficient control block 33A) as described above.

In some embodiments, adaptation of feedforward adaptive filters 32 of high-frequency channel 50A and low-frequency channel 50B may be managed by adapting the feedforward adaptive filters 32 at different time intervals (e.g., feedforward adaptive filter 32 of high-frequency channel 50A adapts for an interval while adaptation of feedforward adaptive filter 32 of high-frequency channel 50B is halted, then in a successive interval, feedforward adaptive filter 32 of high-frequency channel 50B adapts for the successive interval while adaptation of feedforward adaptive filter 32 of high-frequency channel 50A is halted, and so on). In these and other embodiments, adaptation of feedforward adaptive filters 32 may be performed such that adaptation step sizes of the respective adaptive filters 32 are substantially different.

Although the discussion of FIG. 3 above contemplates that high-frequency channel 50A and low-frequency channel 50B of ANC circuit 30A each comprises respective adaptive filters 32, in some embodiments, ANC circuit 30A may comprise a single feedforward adaptive filter 32 which generates a single anti-noise signal from reference microphone signal ref. In such embodiments, such single anti-noise signal may be combined with the low-frequency source audio signal to generate the low-frequency output signal and separately combined with the high-frequency source audio signal to generate the high-frequency output signal. In such embodiments, ANC circuit 30A may also comprise a W coefficient control block 31 which may adapt the adaptive filter 32 based on a correlation between the playback corrected error signal (e.g., pbceₗ) and a second signal, wherein the second signal is the combination of the reference microphone signal ref as filtered by a filter (e.g., filter 34B) applying a low-frequency secondary path estimate response (e.g., a response of SEₗₗCOPY(z) as applied by low-frequency channel 50B) and the reference microphone signal ref as filtered by a filter (e.g., filter 34B) applying a high-frequency secondary path estimate response (e.g., a response of SEₗₕCOPY(z) as applied by high-frequency channel 50A).

Although the discussion of FIG. 3 above contemplates that in some embodiments, high-frequency channel 50A is substantially identical to low-frequency channel 50B, in some embodiments, high-frequency channel 50A may not include components present in low-frequency channel 50B. For example, in some embodiments, low-frequency channel 50B may include adaptive filter 32 and W coefficient control block 31, while high-frequency channel 50A may not include corresponding components. In such an embodiment, high-frequency channel 50A may not generate a high-frequency antinoise signal, and thus, the high-frequency audio signal may simply pass to its associated transducer without added anti-noise. Thus, in such embodiments, high-frequency channel 50A may only include components necessary for adaptation of its secondary path estimate filter 34A.

As used herein, when two or more elements are referred to as “coupled” to one another, such term indicates that such two or more elements are in electronic communication whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosures have been described in detail, it should be understood that various changes, substitutions, and alterations could be made hereto without departing from the spirit and scope of the disclosure.

What is claimed is:

1. An integrated circuit for implementing at least a portion of a personal audio device, comprising:
a first output for providing a first output signal to a first transducer for reproducing a first frequency range content source audio signal comprising first frequency range content of a source audio signal, the first output signal including both the first frequency content source audio signal and an antinoise signal for countering the effects of ambient audio sounds in an acoustic output of an earspeaker comprising the first transducer and a second transducer;
a second output for providing a second output signal to the second transducer for reproducing a second frequency range content source audio signal comprising second frequency range content of the source audio signal, the second output signal including at least the second frequency range content source audio signal;
a reference microphone input for receiving a reference microphone signal indicative of the ambient audio sounds;
an error microphone input for receiving an error microphone signal indicative of the output of the earspeaker and the ambient audio sounds at the earspeaker; and
a processing circuit comprising:
an adaptive filter having a response that generates the antinoise signal from the reference microphone signal to reduce the presence of the ambient audio sounds at the acoustic output, wherein the response of the adaptive filter is shaped in conformity with the reference microphone signal and the error microphone signal by adapting the response of the adaptive filter to minimize the ambient audio sounds in the error microphone signal;
a first signal injection portion which injects a first additional signal into the first frequency range content source audio signal; and
a second signal injection portion which injects a second additional signal into the second frequency range content source audio signal, wherein the first additional signal and the second additional signal are substantially different.

2. The integrated circuit of claim 1, wherein the second output signal includes the second frequency range content source audio signal and the antinoise signal.

3. The integrated circuit of claim 1, wherein:
the second output signal includes the second frequency range content source audio signal and a second antinoise signal for countering the effects of ambient audio sounds in the acoustic output; and
the processing circuit further comprises a second adaptive filter that generates the second antinoise signal from the reference microphone signal to reduce the presence of the ambient audio sounds at the acoustic output, wherein the response of the adaptive filter is shaped in conformity with the reference microphone signal and the error microphone signal by adapting the response of the adaptive filter to minimize the ambient audio sounds in the error microphone signal.

4. The integrated circuit of claim 3, wherein the adaptive filter and the second adaptive filter are adapted at different time intervals.

5. The integrated circuit of claim 3, wherein an adaptation step size of the adaptive filter is substantially different than an adaptation step size of the second adaptive filter.

6. The integrated circuit of claim 1, wherein the processing circuit comprises a feedback filter that generates a feedback antinoise component from the error microphone signal which is combined with a feedforward antinoise component generated by the adaptive filter to generate the antinoise signal.

7. The integrated circuit of claim 1, wherein the first additional signal and the second additional signal are noise signals.

8. The integrated circuit of claim 1, the processing circuit further comprising a crossover filter that generates the second frequency range content source audio signal and the first frequency range content source audio signal from the source audio signal.

9. The integrated circuit of claim 1, the processing circuit further comprising:
a first secondary path estimate filter configured to model an electro-acoustic path of the first frequency range content source audio signal and having a response that generates a first secondary path estimate from the first frequency range content source audio signal;
a first secondary coefficient control block that shapes the response of the first secondary path estimate filter in conformity with the first additional signal and the error microphone signal by adapting the response of the first secondary path estimate filter to minimize the error microphone signal;
a second secondary path estimate filter configured to model an electro-acoustic path of the second frequency range content source audio signal and having a response that generates a second secondary path estimate from the second frequency range content source audio signal; and
a second secondary coefficient control block that shapes the response of the second secondary path estimate filter in conformity with the second additional signal and the error microphone signal by adapting the response of the second secondary path estimate filter to minimize the error microphone signal.

10. The integrated circuit of claim 1, wherein:
the first frequency range content of the source audio signal comprises lower-frequency range content of the source audio signal; and
the second frequency range content of the source audio signal comprises higher-frequency range content of the source audio signal.

11. A method comprising:
generating a source audio signal for playback to a listener;
receiving a reference microphone signal indicative of ambient audio sounds;
receiving an error microphone signal indicative of an output of an earspeaker and the ambient audio sounds at the earspeaker, wherein the earspeaker comprises a first transducer for reproducing a first frequency range content source audio signal comprising first frequency range content of the source audio signal and a second transducer for reproducing a second frequency range content source audio signal comprising second frequency range content of the source audio signal;
adaptively generating an antinoise signal for countering the effects of ambient audio sounds at an acoustic output of the earspeaker by adapting a response of an adaptive filter that filters the reference microphone signal in conformity with the error microphone signal and the reference microphone signal to minimize the ambient audio sounds in the error microphone signal;
injecting a first additional signal into the first frequency range content source audio signal;
injecting a second additional signal into the second frequency range content source audio signal, wherein the first additional signal and the second additional signal are substantially different;
combining the antinoise signal with the first frequency range content source audio signal to generate a first output signal provided to the first transducer; and
generating a second output signal provided to the second transducer, the second output signal including at least the second frequency range content source audio signal.

11. The method of claim 11, further comprising combining the antinoise signal with the second frequency range content source audio signal to generate the second output signal.

13. The method of claim 11, wherein:
adaptively generating a second antinoise signal for countering the effects of ambient audio sounds at the acoustic output by adapting a response of a second adaptive filter that filters the reference microphone signal in conformity with the error microphone signal and the reference microphone signal to minimize the ambient audio sounds in the error microphone signal; and
combining the second antinoise signal with the second frequency range content source audio signal to generate the second output signal.

14. The method of claim 13, further comprising adapting the adaptive filter and the second adaptive filter at different time intervals.

15. The method of claim 13, wherein an adaptation step size of the adaptive filter is substantially different than an adaptation step size of the second adaptive filter.

16. The method of claim 11, further comprising:
generating a feedback antinoise component from the error microphone signal; and
combining the feedback antinoise component with a feedforward antinoise component generated by the adaptive filter to generate the antinoise signal.

17. The method of claim 11, wherein the first additional signal and the second additional signal are noise signals.

18. The method of claim 11, further comprising generating the second frequency range content source audio signal and the first frequency range content source audio signal from the source audio signal with a crossover filter.

19. The method of claim 11, further comprising:
generating a first secondary path estimate from the first frequency range content source audio signal with a first secondary path estimate filter configured to model an electro-acoustic path of the first frequency range content source audio signal;
shaping a response of the first secondary path estimate filter in conformity with the first additional signal and the error microphone signal by adapting the response of the first secondary path estimate filter to minimize the error microphone signal;
generating a second secondary path estimate from the second frequency range content source audio signal with a second secondary path estimate filter configured to model an electro-acoustic path of the second frequency range content source audio signal; and
shaping a response of the second secondary path estimate filter in conformity with the second additional signal and the error microphone signal by adapting the response of the second secondary path estimate filter to minimize the error microphone signal.

20. The method of claim 11, wherein:
the first frequency range content of the source audio signal comprises lower-frequency range content of the source audio signal; and
the second frequency range content of the source audio signal comprises higher-frequency range content of the source audio signal.
